(19) United States
(12) Patent Application Publication
(10) Pub. No.: US 2023/0325820 A1
(43) Pub. Date: Oct. 12, 2023

(54) SYSTEM AND METHOD FOR TOKENIZATION

(71) Applicant: MIH Payments Holdings B.V., Amsterdam (NL)

(72) Inventors: Ravi BATTULA, Bangalore (IN); Bhaumik PATEL, Bangalore (IN)

(21) Appl. No.: 17/715,359

(22) Filed: Apr. 7, 2022

(51) Int. Cl. G06Q 20/38; H04L 9/32

(52) U.S. Cl. CPC G06Q 20/38215; H04L 2209/56; H04L 9/3213; G06Q 20/385

(57) ABSTRACT

A system and method for tokenization are provided. The method receives, from a token requestor, an enrolment request message requesting enrolment of a payment credential for tokenization. The method determines whether to obtain a payment token of a first or second type and obtains the payment token associated with the payment credential. When the first type of token is determined to be obtained: the method generates the first type of token using a tokenization algorithm; stores the first type of token in association with the payment credential; and, transmits the first type of token as the payment token to the token requestor. When the second type of token is determined to be obtained, the method interacts with a network tokenization service to request generation of the second type of token associated with the payment credential for transmitting the second type of token as the payment token to the token requestor.

### FIELD

This technology relates to a system and method for tokenization. Aspects of the present technology relate to a tokenization platform for obtaining a payment token for a payment credential.

### BACKGROUND

A growing segment of digital payments includes so-called “recurring” or “subscription” payments, which require the likes of merchants, acquirers and other financial services providers to provide a seamless consumer experience for repeat payments. These repeat payments can be either merchant initiated (e.g. online subscriptions such as over-the-top, media, utilities, etc.) or customer initiated (e.g. frequently visited merchants, such as e-commerce sites, etc.). In both scenarios, security and convenience are key factors as the consumer trusts the merchant to store their payment credentials securely to enable a faster or lower-friction checkout experience.

Currently there is no industry standard or globally accepted norms to provide these features in a consistent manner, and requirements might vary from region by merchants, acquirers, financial services providers and the like. For example, the Reserve Bank of India has published guidelines specifying or restricting the entities which can store card credentials, pressuring merchants, acquirers, financial services providers and the like to adopt standards set out in the guidelines. The guidelines require, for example, that neither authorised payment aggregators nor the merchants on-boarded by them shall store customer card credentials (also known as “Card-on-File”, “Credential-on-File” or “CoF”).

While tokenization, being a process by which a primary account number (PAN) is replaced with a surrogate value called a token, may be turned to in an attempt to improve security and convenience in recurring or subscription payments, there remain shortcomings. For example, network tokenisation services, such as the Visa Tokenization Service (VTS) or the Mastercard Digital Enablement Service (MDES), can be cumbersome (and costly) to implement, and can be associated with a higher transaction latency due to the number of hops required to process a transaction, which can negatively impact on performance during, for example, high load periods.

There is accordingly scope for improvement.

The preceding discussion of the background is intended only to facilitate an understanding of the present technology. It should be appreciated that the discussion is not an acknowledgment or admission that any of the material referred to was part of the common general knowledge in the art as at the priority date of the application.

### SUMMARY

In accordance with an aspect of the technology there is provided a computer-implemented method conducted at a tokenization platform, comprising: receiving, from a token requestor, an enrolment request message requesting enrolment of a payment credential for tokenization; determining whether to obtain a payment token of a first type or a second type for the payment credential; and, obtaining the payment token associated with the payment credential, including: when the first type of token is determined to be obtained: generating the first type of token using a tokenization algorithm; storing the first type of token in association with the payment credential in a secure storage location accessible to the tokenization platform; and, transmitting the first type of token as the payment token to the token requestor for use in submitting one or more payment requests; and, when the second type of token is determined to be obtained: interacting with a network tokenization service to request generation of the second type of token associated with the payment credential for transmitting the second type of token as the payment token to the token requestor for use in submitting one or more payment requests.

The payment token may be obtained for storage and subsequent use by the token requestor in submitting one or more payment requests. The enrolment request message may include data elements relating to one or more predefined conditions to be associated with the payment token.

The method may include generating the first type of token including accessing a bank identification number (BIN) from a BIN range associated with an issuer of the payment credential. The method may include generating the first type of token including generating the first type of token without a BIN. The method may include generating the first type of token including generating a character sequence that passes a validation algorithm. The method may include generating the first type of token including generating a numerical sequence that passes a validation algorithm, wherein the validation algorithm is a Luhn algorithm.

Determining whether to obtain the payment token of the first type or the second type may include parsing the enrolment request message for one or more data elements instructing generation of the first type of token or the second type of token. Determining whether to obtain the payment token of the first type or the second type may include checking whether the first type of token is supported for the payment credential. Determining whether to obtain the payment token of the first type or the second type may include evaluating the enrolment request message against rules associated with one or both of the payment credential and the token requestor. Determining whether to obtain the payment token of the first type or the second type may include evaluating contextual information included in or associated with the enrolment request message.

The token requestor may be a computing device of one of: a consumer; a merchant; a payment services provider; a payment gateway; or, a payment aggregator.

The method may include receiving, from a payment requestor, a payment credential request message, the payment credential request message including the payment token and requesting the payment credential associated with the payment token, obtaining the payment credential associated with the payment token, and, transmitting the payment credential to the payment requestor for submitting to a payment processing network to process a payment.

The payment requestor may be a computing device of one of: a merchant; a payment services provider; a payment gateway; or, a payment aggregator. The payment requestor and the token requestor may be one and the same.

The first type of token may be an issuer token and the second type of token may be a network token.

In accordance with another aspect of the technology there is provided a system including a tokenization platform including a memory for storing computer-readable program code and a processor for executing the computer-readable program code, the system comprising: an enrolment request message receiving component for receiving, from a token requestor, an enrolment request message requesting enrolment of a payment credential for tokenization; a token type determining component for determining whether to obtain a payment token of a first type or a second type for the payment credential; and, a payment token obtaining component for obtaining the payment token associated with the payment credential, including: for when the first type of token is determined to be obtained: a token generating component for generating the first type of token using a tokenization algorithm; a payment token storing component for storing the first type of token in association with the payment credential in a secure storage location accessible to the tokenization platform; and, a payment token transmitting component for transmitting the first type of token as the payment token to the token requestor for use in submitting one or more payment requests; and, for when the second type of token is determined to be obtained: a network tokenization service interacting component for interacting with a network tokenization service to request generation of the second type of token associated with the payment credential for transmitting the second type of token as the payment token to the token requestor for use in submitting one or more payment requests.

The system may include a payment credential request message receiving component for receiving, from a payment requestor, a payment credential request message, the payment credential request message including the payment token and requesting the payment credential associated with the payment token, a payment credential obtaining component for obtaining the payment credential associated with the payment token, and, a payment credential transmitting component for transmitting the payment credential to the payment requestor for submitting to a payment processing network to process a payment.

The system may include a computing device of the payment requestor, including, a payment credential request message transmitting component for transmitting the payment credential request message, a payment credential receiving component for receiving the payment credential, and, a payment credential submitting component for submitting the payment credential to a payment network for processing a payment.

In accordance with a further aspect of the technology there is provided a computer program product comprising a computer-readable medium having stored computer-readable program code for performing, at a tokenization platform, the steps of: receiving, from a token requestor, an enrolment request message requesting enrolment of a payment credential for tokenization; determining whether to obtain a payment token of a first type or a second type for the payment credential; and, obtaining the payment token associated with the payment credential, including: when the first type of token is determined to be obtained: generating the first type of token using a tokenization algorithm; storing the first type of token in association with the payment credential in a secure storage location accessible to the tokenization platform; and, transmitting the first type of token as the payment token to the token requestor for use in submitting one or more payment requests; and, when the second type of token is determined to be obtained: interacting with a network tokenization service to request generation of the second type of token associated with the payment credential for transmitting the second type of token as the payment token to the token requestor for use in submitting one or more payment requests.

Further features provide for the computer-readable medium to be a non-transitory computer-readable medium and for the computer-readable program code to be executable by a processing circuit.

Embodiments of the technology will now be described, by way of example only, with reference to the accompanying drawings.

### BRIEF DESCRIPTION OF THE DRAWINGS

In the drawings:

FIG. 1 is a schematic diagram which illustrates one example embodiment of a system for tokenization according to aspects of the present disclosure;

FIG. 2 is a schematic diagram which illustrates example token provision and token processing stages according to aspects of the present disclosure;

FIG. 3 is a swim-lane flow diagram which illustrates an exemplary method for tokenization according to aspects of the present disclosure in which respective swim-lanes delineate steps, operations or procedures performed by respective entities or devices;

FIG. 4 is a schematic diagram which illustrates example token provision operations according to aspects of the present disclosure;

FIG. 5 is a schematic diagram which illustrates example token processing operations according to aspects of the present disclosure

FIG. 6 is a schematic diagram which illustrates one example embodiment of integration of a tokenization platform according to aspects of the present disclosure into an existing payment infrastructure;

FIG. 7 is a block diagram illustrating example components of one embodiment of a tokenization system according to aspects of the present disclosure; and,

FIG. 8 illustrates an example of a computing device in which various aspects of the disclosure may be implemented.

### DETAILED DESCRIPTION WITH REFERENCE TO THE DRAWINGS

Aspects of the present disclosure provide a system and method for tokenization, including, for example, a tokenization platform for obtaining a payment token for a payment credential. The tokenization platform may expose a smart tokenization application programming interface (API) to determine the nature of tokenization and whether to use network, issuer or device level implementation. Aspects of the present disclosure may provide a system and method for contextual tokenization, which may be based on ‘channel’, ‘device’, ‘network’ and the like. The tokenization platform described herein may provide an integrated tokenization solution for networks, issuers and devices.

For example, responsive to receiving an enrolment request message requesting enrolment of a payment credential for tokenization, the tokenization platform according to aspects of the present disclosure may determine whether to obtain a payment token of a first type or a second type for the payment credential. This determination may use contextual information associated with the enrolment request message. For example, contextual information included in or associated with the enrolment request message may be evaluated as a part of the determination. The message may be parsed for one or more data elements instructing generation of either the first or second type of data elements. The determination may include checking whether the first type of token is supported for the payment credential (or the issuer of the payment credential). The determination may include evaluating the enrolment request message against rules associated with one or both of the payment credential, the issuer of the payment credential and the token requestor. The tokenization platform may obtain a payment token associated with the payment credential in accordance with the determination, including, for example either generating the first type of token or obtaining the second type of token from a tokenization service, as may be required.

The first type of token may be a so-called issuer token. The second type of token may be a so-called network token. The contextual tokenization described herein can leverage advantages associated with each type of token based on contextual information associated with an enrolment request message.

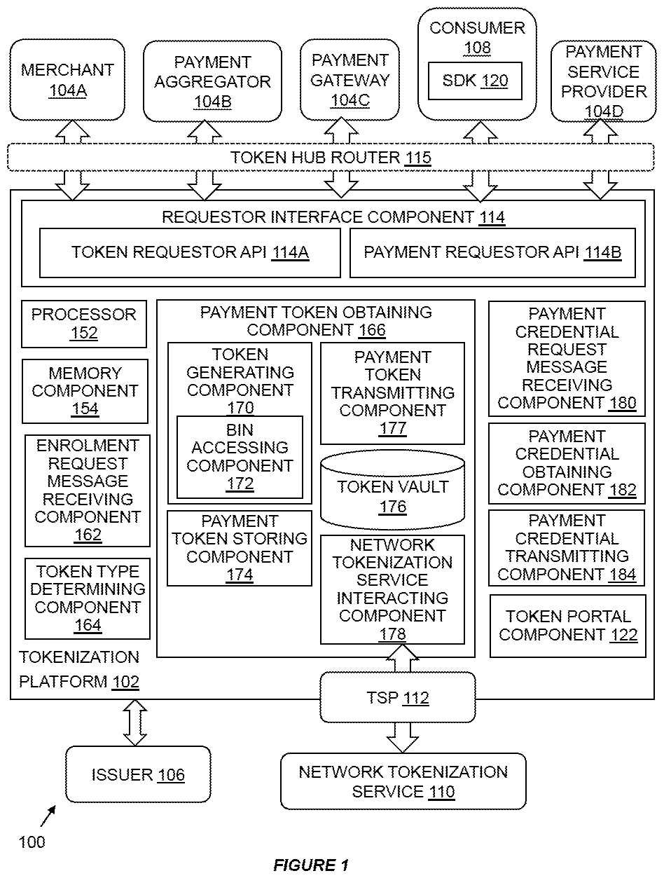

FIG. 1 is a schematic diagram which illustrates one example embodiment of a system (100) for tokenization according to aspects of the present disclosure. The system includes a tokenization platform (102).

The tokenization platform (102) may be in data communication with computing devices of one or more of: a merchant (104A); a payment aggregator (104B); a payment gateway (104C); a payment services provider (104D); and, a consumer (108), each of which may, depending on the implementation, operate as a token requestor in the system and method described herein.

Each of the token requestors may interface with the tokenization platform via a suitable requestor interface component (114), which may for example include one or both of a token requestor application programming interface (API) (114A) and payment requestor API (114B). In some embodiments, one or more of the token requestors interact with the tokenization platform via a token hub router (115). The requestor interface component (114) may provide a token gateway and may for example enable ‘add’, ‘modify’ and/or ‘delete’ operations to data stored in a secure storage of the tokenization platform (such as a token vault). The token hub router (115) may provide functionality for routing of token requests (such as enrollment or payment credential request messages) to respective issuer or network based on, for example, one or both of token requestor eligibility and subscription. The token hub router (115) may form part of the tokenization platform (102).

Computing devices of one or more of the merchant (104A); payment aggregator (104B); payment gateway (104C); payment services provider (104D); and, consumer (108) may, depending on the implementation, operate as a payment requestor in the system and method described herein.

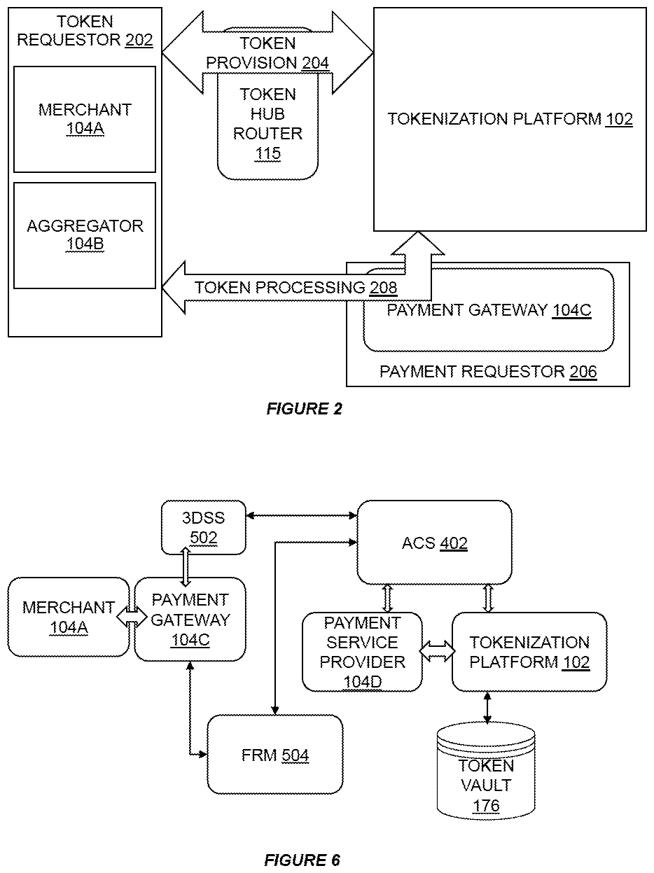

For example, referring to FIG. 2, the merchant (104A) and/or aggregator (104B), acting as token requestor (202), may interact with the tokenization platform (102) for token provision (204) operations. The payment gateway (104C), acting as a payment requestor (206), in a token processing (208) stage, may interact with the tokenization platform (102) on behalf of the merchant (104A) and/or aggregator (104B). Other arrangements of token requestor and payment requestor are envisaged.

Returning to FIG. 1, tokenization platform (102) may be in data communication with computing devices of an issuer (106) and a network tokenization service (110). Communication with the one or more network tokenization service may be via a token service provider (TSP) (112), such as a token requestor TSP (TR-TSP) or an issuer TSP (I-TSP). The issuer (106) may provide or have access to an issuer token service for issuing their own tokens instead of using tokens from a network tokenization service.

In some embodiments, the computing device of the consumer (108) may have resident therein and/or installed thereon a token software development kit (SDK) (120) configured to manage and/or facilitate device tokenization, including for example interacting with the tokenization platform (102) for requesting and receiving a payment token. The SDK (120) may for example provide functionality for card storage beyond consumer CoF for commercial cards. The token SDK (120) may include or provide SDK for each of various card networks and may be configured to interact with the tokenization platform and/or the respective card networks for transmitting enrolment request messages and receiving payment tokens. The token SDK (120) may further be configured to interact with a merchant as a payment requestor for providing the payment token for making a payment.

Although only one of each of the merchant (104A), payment aggregator (104B), payment gateway (104C), payment services provider (104D), consumer (108), issuer (106) and network tokenization service (110) are described and illustrated, it should be appreciated that in a practical implementation there may be a plurality of each of these. Computing devices of the respective entities may be in data communication with the tokenization platform (102) and/or each other via one or more suitable communication networks via which data and/or messages may be transmitted and received.

The tokenization platform (102) may include a processor (152) for executing the functions of components described below, which may be provided by hardware or by software units executing on the tokenization platform (102). The software units may be stored in a memory component (154) and instructions may be provided to the processor (152) to carry out the functionality of the described components.

The tokenization platform (102) may include an enrolment request message receiving component (162) arranged to receive an enrolment request message requesting enrolment of a payment credential for tokenization. The enrolment request message may be received from a token requestor, for example via the token requestor API (114A). The enrolment request message may include data elements relating to one or more predefined conditions to be associated with the payment token (such as a merchant identifier, consumer device identifier, etc.; a number of transactions for which the token is valid; a period of time for which or deadline until which the token is valid, and the like).

The tokenization platform (102) may include a token type determining component (164) arranged to determine whether to obtain a payment token of a first type or a second type for the payment credential. The token type determining component (164) may be configured to: parse the enrolment request message for one or more data elements instructing generation of the first type of token or the second type of token; check whether the first type of token is supported for the payment credential; evaluate the enrolment request message against rules associated with one or both of the payment credential and the token requestor; and/or evaluate contextual information included in or associated with the enrolment request message to determine an appropriate type of token to be generated based on the contextual information.

The tokenization platform (102) may include a payment token obtaining component (166) arranged to obtain the payment token associated with the payment credential. The payment token may be obtained for storage and subsequent use by the token requestor in submitting one or more payment requests (such as recurring or subscription payments). The payment token obtaining component (166) may obtain the payment token in accordance with the determination of the token type determining component (164).

The payment token obtaining component (166) may include a token generating component (170) arranged to generate a payment token using a tokenization algorithm. The token generating component (170) may generate the payment token with or without a bank identification number (BIN). The token generating component may include a BIN accessing component (172) arranged to retrieve a BIN associated with an issuer of the payment credential if the payment token is to include the BIN. The BIN may be retrieved from a BIN range associated with the issuer of the payment credential. The token generating component (170) may generate the payment token in the form of a character sequence (such as a numerical sequence) which passes a validation check performed by a validation algorithm (such as the Luhn algorithm). The token generating component (170) may generate a payment token of the first type. The token generating component (170) may generate a token of the first type.

The payment token obtaining component (166) may include a payment token storing component (174) arranged to store the payment token in association with the payment credential and predefined conditions (if any). The payment token storing component (174) may be arranged to store the payment token and payment credential (or link to the payment credential) in a secure storage location accessible to the tokenization platform (102), such as a token vault (176). The token vault (176) may for example be in the form of a secure token store and may for example be built to EMVCo, PCI-DSS standards and the like. The token vault (176) may be configured to facilitate generation and/or management of tokens with domain and/or merchant related controls. The payment token storing component (174) may be arranged to store only tokens of the first type.

The payment token obtaining component (166) may include a payment token transmitting component (177) arranged to transmit the payment token to the token requestor for use in submitting one or more payment requests.

The payment token obtaining component (166) may include a network tokenization service interacting component (178) arranged to interact with the network tokenization service (110) to request generation of the payment token associated with the payment credential for transmitting to the token requestor for use in submitting one or more payment requests. The interaction may be via the TSP (112). The payment token may be generated by the network tokenization service (110) and may be of the second type. The payment token may be returned to the tokenization platform for transmission to the token requestor, or may be transmitted to the token requestor by the network tokenization service (110).

The payment token obtaining component (166) may be arranged to obtain a payment token of either the first type or the second type depending on the determination of the token type determining component (164). Different characteristics, properties and/or benefits of the different types of token are set out below for an example embodiment in which the first type of token is an issuer token and the second type of token is a network token.

| Use cases | Issuer Token | Network Token | Benefits |
|---|---|---|---|
| Performance | High | Low | |
| Number of hops | One single call to | At least 3 hops. | Higher |
| | detokenize/retrieve card | - 1 hop | performance. |
| | # | authentication [DS | During peak loads |
| | | look up] | like sale period |
| | | - Get Cryptogram | Issuer tokens will |
| | | before every | be highly |
| | | authorization | performant |
| | | - During | |
| | | Authorization | |
| | | network look up for | |
| | | token | |
| Transaction latency | Low (One single | High (Multiple hops | Result in higher |
| | detokenize call) | leads to higher | Success Rate of |
| | | latency) | Transactions (SRT) |
| | | | with minimum |
| | | | failures |
| Transaction Success | High | Low | High latency will |
| Rate | | | lower the success |
| | | | rate due to system, |
| | | | network or |
| | | | customer |
| | | | abandonment |
| Commercial Aspects | | | |
| On-Us Support | Possible | Not possible | Existing Merchant |
| | | | benefits, DI support |
| | | | possible |
| Cost of processing | Low | High | On-us transactions |
| | | | can continue to |
| | | | benefit even using |
| | | | Issuer tokens |
| Business Scenarios* | | | |
| Equated monthly | Supported | Partially supported | Token mapping to |
| instalment (EMI) | | | underlying PAN |
| | | | possible to support |
| Pay-out | Supported | Partially supported | Token mapping to |
| | | | underlying PAN |
| | | | possible to support |
| Loyalty | Supported | Not supported | Token mapping to |
| | | | underlying PAN |
| | | | possible to support |
| Risk models | Supported | Partially supported | Existing Risk |
| | | | models can be |
| | | | supported with PAR |
| | | | & PAN |
| Commercial cards - | Supported | Not supported | Easily support |
| GDS, AP/AR etc. | | | commercial card |
| | | | use cases without |
| | | | any disruption |
| VAS - Tokenization* | | | |
| Product Code | Supported | Not supported | Specific product |
| identification | | | code associated |
| | | | with the token PAN |
| | | | can be included |
| Offers on token | Supported | Not supported | Based on product |
| | | | code offers and |
| | | | product specific |
| | | | processing possible |
| Express Pay support | Supported | Not supported | One-click checkout |
| | | | using |
| | | | ExpressPay/3DSS |
| | | | can be |
| | | | implemented |
| 3DS2.0 integration | Supported | Supported | Support for 3DS2.0 |
| | | | can be achieved |
| | | | during express pay |
| | | | integration itself |
| Fraud and risk | Supported | Supported | Fraud and risk |
| support | | | models using |
| | | | Token and PAR |
| | | | supported |
| Support for non-card | Supported | NA | Non card payment |
| payments | | | instruments can be |
| | | | included in future |

Network tokenization may for example be considered a close ended program, might suffer from high levels of churn and participation barrier and may be tightly coupled via TSPs and issuer enrolment. In terms of coverage, eligibility for all issued cards across all schemes for tokenization may not be possible. Data monetization may be possible for the payment network, for example through offers, loyalty, rewards, personalization and the like. However, an additional fee for participation by issuers may be payable by issuers, without providing the ability for the issuers to monetize data in the same way as the networks.

Network tokenization can be complicated and cumbersome for participants, with a high entry barrier (e.g. relating to registering and certifying for TR-TSP, and the like) with heavy dependence on networks. Network tokenization may require multiple hops for authentication and authorization. Network tokenization may for example require an additional 3 hops for every transaction checkout as compared to non-tokenization or issuer-based tokenization. Network tokenization can therefore lower performance in certain circumstances. Network tokenization may lack support for on-us, pay-outs, loyalty, express pay, issuer based EMI and acquiring fraud scenarios (e.g. fraud data models may break as tokens will not be identified). Merchant-side data models and analytics may also cease to be effective. For example, a merchant, payment aggregator, payment gateway and acquirer may only have access to the network token whereas the issuer only has access to the payment credential (while the payment network does the mapping from token to credential and vice versa).

Issuer tokenization, on the other hand, may provide a more flexible, open-ended solution. Plug and play with merchants, aggregators, payment gateways, PSPs and the like may be supported. Full coverage of all cards across all card schemes may be provided and without any additional fee requiring to be paid for networks. Further monetization may be possible (e.g. via “TaaS”, or “Tokenization as a Service”).

Issuer tokenization may enable the generation of ‘On-Us’ tokens for greater data control and monetization. On-Us tokens can be consumed by any merchant, acquirer or aggregator. Issuer tokenization may provide support for pay-outs and EMI use cases seamlessly as well as higher success rates through ‘On-Us’ routing and bespoke arrangements. Issuer tokenization may provide support for commercial card use cases (GDS, AP/AR) and/or native integration with ACS, FRM, PG for higher performance. Issuer tokenization may enable a financial institution to offer VAS (missing in network tokens) using On-Us tokenization for its acquiring customers thereby increasing stickiness and monetizing the same. Issuer tokenization may enable Express Pay using tokens, loyalty and cashback on tokens and/or FRM for tokens. Issuer tokenization may enable extension to device tokens for contactless payments to improve customer experience

The tokenization platform (102) may include a payment credential request message receiving component (180) arranged to receive a payment credential request message requesting the payment credential associated with the payment token. The payment credential request message may be received from a payment requestor, for example via the payment requestor API (114B). The payment credential request message may include the payment token and may optionally include other transaction related data.

The tokenization platform (102) may include a payment credential obtaining component (182) arranged to obtain the payment credential associated with the payment token. The payment credential obtaining component (182) may be configured to obtain the payment credential from the token vault (176), for example by retrieving the payment credential associated with the payment token from the token vault (176).

The tokenization platform (102) may include a payment credential transmitting component arranged to transmit the payment credential to the payment requestor for submitting to a payment processing network to process a payment. Transmission may be via the payment requestor API (114B).

The tokenization platform (102) may include a token portal component (122) which may for example provide a user portal via which a consumer can manage the token lifecycle, for example by adding, modifying or replacing payment tokens and/or generating and viewing reports and/or analytics relating to payment tokens and their use. The token portal component (122) may provide the user portal via one or more of the following channels: mobile application, Internet banking, interactive voice response (IVR) and/or physical locations (such as branches/offices, etc.).

The components of the tokenization platform may thus provide a token hub having a card-on-file (CoF) token vault for storing issuer tokens, CoF network tokenization functionality and network device tokenization functionality. The tokenization platform (102) may provide on-us tokenization functionality to a plurality of issuers. The tokenization platform (102) may provide an EMVCo and/or PCI-DSS compliant token hub integrated with an access control server (ACS) so as to provide minimal disruption and faster time to market. The tokenization platform may provide one time tokenization for payment credentials issued by integrated issuers' cards as well as secure storage of payment tokens and/or payment credentials in bank token vaults. The tokenization platform may support token APIs via a token portal for issuers, aggregators, payment gateways and merchants to access the tokens.

The tokenization platform (102) may provide various utilities to support post tokenization issues/use cases, including for example: issuer portal support for token management; EMI payments; PAN to Token BIN mapping; PAN mapping from ACS to support timely pay-out for pay-outs Support; Payment Account Reference (PAR) to support fraud, risk, analytics with unique reference to PAN; and, seamless conversion of network tokens to on-us tokens for higher SRT, lower cost. EMI may be provided to convert an amount relating to a purchase to equal monthly instalments. A pay-out may be equivalent to a disbursement, for example using a third party application to make payment to the payment credential.

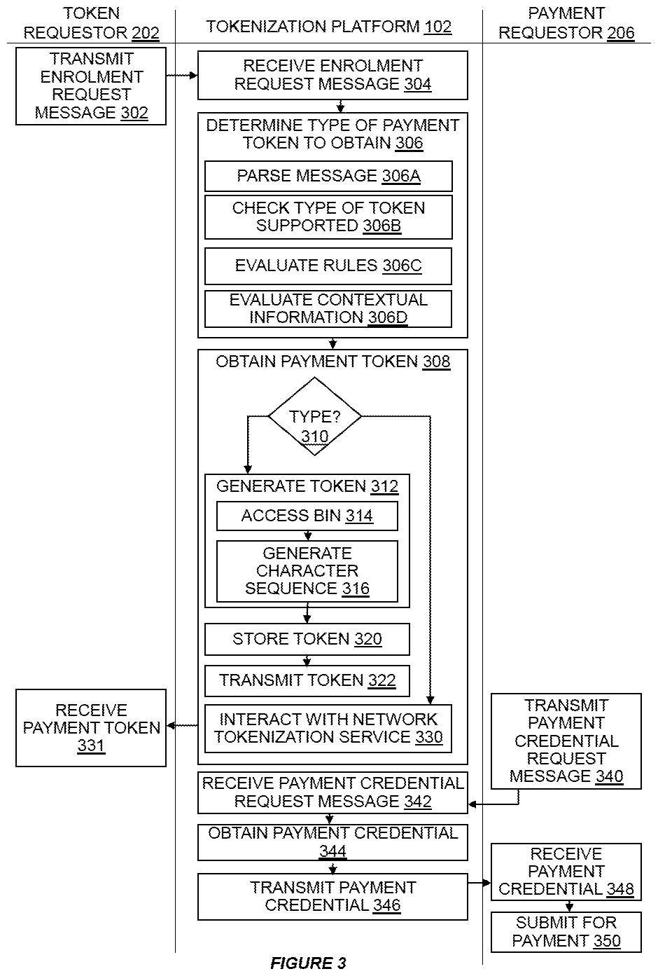

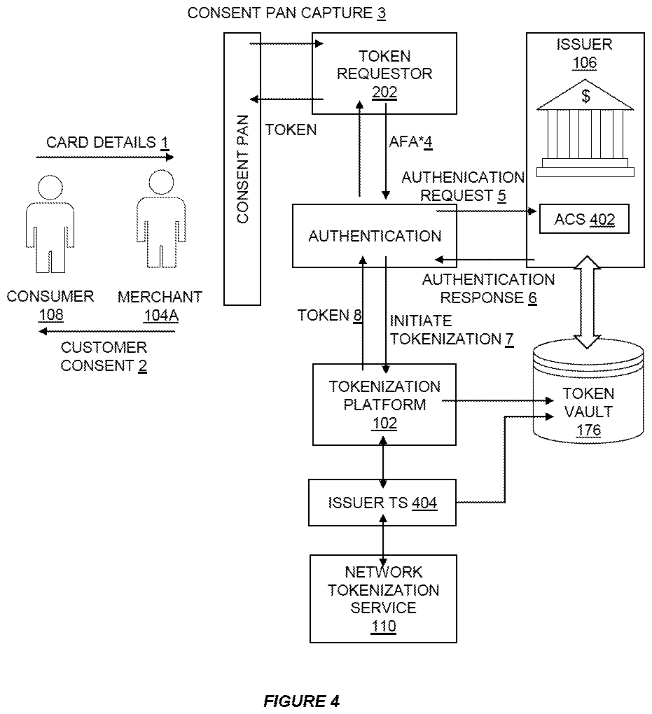

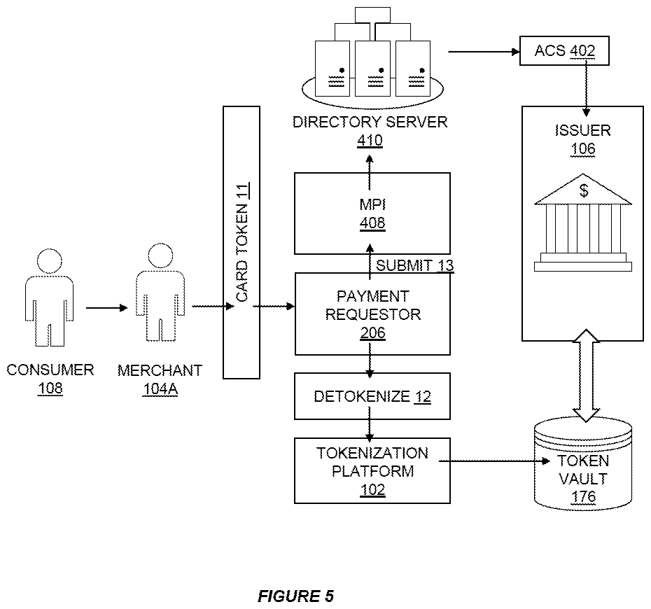

The system (100) described above may implement a method for tokenization. An exemplary method for tokenization is illustrated in the swim-lane flow diagram of FIG. 3, in which respective swim-lanes delineate steps, operations or procedures performed by computing devices of the respective entities. The method described with reference to FIG. 3 includes operations relating to both token provision and token processing stages, and example scenarios relating to each of these stages are described with reference to FIGS. 4 and 5 respectively.

In a token provision stage, a token requestor (202) may generate and transmit (302) an enrolment request message requesting enrolment of a payment credential for tokenization. The enrolment request message may be transmitted to the tokenization platform, for example via a requestor interface component (114). The enrolment request message may include the payment credential and optionally other enrolment-related data, such as data elements relating to one or more predefined conditions to be associated with the payment token. The enrolment request message may for example include data elements: instructing generation of a first or second type of token; indicating a type of token supported for the payment credential; and/or other contextual information. The enrolment request message may include an identifier of a merchant for whom the payment credential is being enrolled. The enrolment request message may include a device identifier of a consumer computing device for which the payment credential is being enrolled. The enrolment request message may include rules with which the payment token is to be associated, such as a number of transactions for which the token is to be valid, an expiry date, a total transaction amount or the like.

For example, referring to FIG. 4, a consumer (108) may provide (1) his or her payment credential to a merchant (104A) for the purpose of enrolment for tokenization. The merchant may in turn obtain (2) consumer consent and may then transmit (3) the payment credential together with the consumer consent (the consent PAN capture) to an aggregator, payment gateway, or the like for requesting enrolment of the payment credential for tokenization. Consumer consent may be used to validate user confirmation before proceeding with any tokenization transaction. The aggregator, payment gateway or the like, acting as the token requestor, may then generate and transmit the enrolment request message to the tokenization platform (102). In some embodiments, transmitting the enrolment request message may be preceded by an additional factor authentication (AFA) flow (4), which may for example entail transmitting (5) an authentication request message to and receiving (6) an authentication response message from an ACS (402) associated with the issuer of the payment credential, after which tokenization may be initiated (7) and the enrolment request message sent to the tokenization platform.

Returning to FIG. 3, the tokenization platform (102) may receive (304) the enrolment request message from the token requestor (202), for example via the requestor interface component (114).

The tokenization platform (102) may determine (306) whether to obtain a payment token of a first type or a second type for the payment credential. Determining whether to obtain the payment token of the first type or the second type may include one or more of: parsing (306A) the enrolment request message for one or more data elements instructing generation of the first type of token or the second type of token; checking (306B) whether the first type and/or second type of token is supported for the payment credential; evaluating (306C) the enrolment request message against rules associated with one or both of the payment credential and the token requestor; evaluating (306D) contextual information included in or associated with the enrolment request message; and, the like.

Evaluating (306D) contextual information included in or associated with the enrolment request message may include evaluating data elements relating to one or more of: channel, device, network, merchant identifier, consumer device identifier, type or category of goods or services, CIT or MIT usage, time of day, day of week, time of month, time of year, merchant location, consumer location, payment amount, and the like. Data elements relating to ‘channel’ may include an indication of the channel via which the enrolment request is initiated or received, for example being one of: online browser, mobile application or the like. Data elements relating to ‘device’ may include an indication of the device from which the enrolment request is initiated or received, for example being one of: smart watch, mobile phone, automobile computing device, Internet of Things-(IoT-)based computing device or the like. Data elements relating to ‘network’ may include an indication of the payment network with which the payment credential is associated, for example being one of a Visa, Mastercard, American Express, Issuer, and the like. (Visa, Mastercard and American Express are trade marks and may be registered by their respective proprietors.)

Evaluating (306D) contextual information included in or associated with the enrolment request may include evaluating one or both of contextual information relating to an issuer of the payment credential and contextual information relating to the device and/or channel associated with the enrolment request. For example, in some implementations, if the enrolment request is received from a browser for a payment credential which is of the same issuer as a token requestor for which the request is generated, then the first type of token may be determined to be obtained. Conversely, if the enrolment request is received from consumer device (even if for the same issuer), then the second type of token may be determined to be obtained.

The tokenization platform (102) may obtain (308) the payment token associated with the payment credential. Obtaining (308) the payment token may be responsive to and in accordance with the determination as to the type of token to obtain. The payment token is obtained for storage and subsequent use by the token requestor or a payment requestor in submitting one or more payment requests. Obtaining (308) the payment token may include obtaining a graphical representation of the token, for example by encoding the payment token into a graphical code (such as a QR code, barcode or the like). Other forms of encoding may also be used.

If or when (310) the first type of token is determined to be obtained, obtaining (308) the payment token may include generating (312) the first type of token using a tokenization algorithm. The tokenization algorithm may be a proprietary algorithm. This may include generating the first type of token with (including) or without (excluding) a BIN. If the token is generated with or including the BIN, the tokenization platform may access (314) the BIN from a BIN range associated with an issuer of the payment credential. Generating (312) the first type of token includes generating (316) a character sequence (such as a numerical sequence, e.g. in the form of a 16 or 19 digit number) that passes a validation algorithm (such as the Luhn algorithm). In other words, the tokenization algorithm may generate a character sequence that optionally includes a BIN occupying a predetermined location in the sequence and a predetermined number of additional characters which, together with the BIN are capable of uniquely identifying the payment credential and which also pass the predetermined validation algorithm. Excluding the BIN from the payment token may increase flexibility and increases the number of digits available for use (a BIN can require up to 6 of the 16 or 19 digits available).

The tokenization platform (102) may store (320) the first type of token in association with the payment credential in a secure storage location accessible to the tokenization platform, such as a token vault (176).

The tokenization platform (102) may transmit (322) the first type of token as the payment token to the token requestor (202) for use in submitting one or more payment requests. Transmission may be via the requestor interface component (114).

If or when (310) the second type of token is determined to be obtained, obtaining (308) the payment token may include interacting (330) with a network tokenization service (110) to request generation of the second type of token associated with the payment credential for transmitting the second type of token as the payment token to the token requestor (202) for use in submitting one or more payment requests.

Referring again to the example scenario of FIG. 4, depending on the type of token to be obtained, the tokenization platform interacts with one or more of the token vault (176), the issuer (106) (e.g. to access the BIN range, in some embodiments via an issuer token service (404)) and the network tokenization service (110) to obtain the payment token. Once obtained, the tokenization platform (102) returns (8) the payment token to the token requestor (202), which, in the illustrated example, passes (9) the payment token back to the merchant (104) for the merchant to use in submitting subsequent payment requests.

The token requestor (202) may receive (331) the payment token from the tokenization platform (102) or the network tokenization service (110), as the case may be. Depending on the implementation and which entity is acting as the token requestor, the token requestor may store or transmit the payment token to another entity for use in submitting subsequent payment requests against the payment token (and ultimately the payment credential).

The payment token may be associated with predefined conditions and the merchant (or token requestor in some embodiments) can store the payment token and can use it for submitting subsequent payment requests in line with the predefined conditions. Such payment requests can be subscription or recurring payments, and may for example be a merchant initiated transaction (MIT) or a consumer initiated transaction (CIT).

At some later point, in a token processing stage, the merchant (104A) may submit the payment token with or for a payment request. For example, referring to the example scenario of FIG. 5, the merchant (104A) may submit (11) the payment token to a payment requestor, such as a payment gateway, aggregator, payment services provider or the like. The payment requestor may proceed to submit a payment request in accordance with the payment token (e.g. in accordance with the type of payment token). This submission may be merchant or consumer initiated. In the case of a consumer initiated submission, the consumer may select the payment token to be used for the transaction (which may be identifiable using the last four digits thereof, for example).

In some embodiments, for example if the payment token is of the first type, the payment requestor (206) may detokenize (12) the payment token within the transaction session, for example by generating and transmitting (340) a payment credential request message requesting the payment credential associated with the payment token. This may be based on the payment requestor's subscription to a token service of the tokenization platform enabling detokenization via, e.g. the payment requestor API. The payment credential request message may be transmitted (340) to the tokenization platform (102), for example via the requestor interface component (114). The payment credential request message may include the payment token and optionally other transaction related data.

The tokenization platform (102) may receive (342) the payment credential request message from the payment requestor (206). The tokenization platform (102) may obtain (344) the payment credential associated with the payment token. For example, in the case of the payment token being of the first type, the tokenization platform may obtain the payment credential associated with the payment token from the token vault (176). Obtaining the payment credential may include evaluating the payment token and/or payment credential request message against any predefined conditions associated with the payment token. If the predefined conditions are not met, the obtaining operation may fail.

The tokenization platform (102) may transmit (346) the payment credential to the payment requestor (206) for submitting to a payment processing network to process a payment.

The payment requestor (206) may receive (348) the payment credential and may submit (350) the payment credential optionally together with other transaction related data to a payment network for processing the transaction.

In some embodiments, if the payment token is of the second type, the payment requestor (206) may submit (350) the payment token optionally together with other transaction related data to a payment network for processing the transaction.

With reference again to FIG. 5, submitting the payment credential or payment token, as the case may be, may include the payment requestor (206) submitting (13) the payment credential or payment token to the payment network including for example, a merchant plug-in (MPI) (408), directory server (DS) (410), ACS (402) and the like for additional authentication factor authentication of the payment, if required. In other embodiments, the payment credential may be submitted for payment in other ways and/or via other entities or components.

The system and method described herein may therefore provide a tokenization platform for providing tokenization as a service. The tokenization platform may be configured to offer issuer and network tokenization using a single API, with dynamic context selected by merchant selection for determining the type of token to obtain and return. The tokenization platform may make use of an issuer tokenization algorithm configured to generate a token using a BIN range and which passes or satisfies a Luhn or other appropriate validation check. The tokenization platform may be configured with functionality to switch between network and issuer tokens seamlessly and without business disruption.

The tokenization platform may be built to EMVCo standards and may be configured to provide a unified tokenisation solution for Card on File transactions, recurring subscription payments and device tokenisation for so-called “Tap n Pay” contactless payments for merchants, acquirers and other service providers. The tokenization platform is configured to support card network tokens and issuer specific tokens using single integration. The tokenization platform may be deployed and/or built in partnership with major card networks and leading issuers facilitating both network and issuer tokens. The tokenization platform may provide Tokenisation as a Service hosted in the cloud for fast integration supporting global data privacy considerations. The tokenization platform may be fully customizable per region, tenant and merchant and may integrate seamlessly with one or more payment gateways, three domain secure service (3DSS) components, access control servers (ACS) and other host/enterprise ecosystems for a smooth and frictionless payment experience. The tokenization platform may include a 3DSS component in the form of a merchant/payment gateway plug-in to initiate online card transactions adhering to EMVCo 3DS2.0 protocol and the like. The tokenization platform may be configured with plug and play architecture to enable follow on payment use cases for loyalty, offers and standing instructions for recurring payments without losing payment optimizations such a one-click payments and ‘On-Us’ processing. The tokenization platform may be extensible to tokenize non-card instruments (such as UPI, Net Banking, Wallets or other non-card payments) and/or to create a one-click frictionless check out experience online and offline with fully customizable checkout flows for issuers.

FIG. 6 is a schematic diagram which illustrates one example embodiment of integration of a tokenization platform (102) according to aspects of the present disclosure into an existing payment infrastructure for the purpose of obtaining, processing and/or detokenization payment tokens of the first type.

The tokenization platform (102) has access to a token vault (176). The tokenization platform interfaces with an ACS (402) and one or more payment services providers (104D). The ACS (402) interfaces with the one or more payment services providers (104D), a 3DSS (502) and a financial risk manager (FRM) component (502). A payment gateway (104C) may in turn interface with the 3DSS (502) and FRM component (504) as well as with a merchant (104A). Such integration may for example enable embodiments of the method described above with reference to FIGS. 3 to 5. Such an integration may provide an end-to-end framework for seamless, simple, cost effective and scalable recurring payments. Other integrations of the tokenization platform are also envisaged.

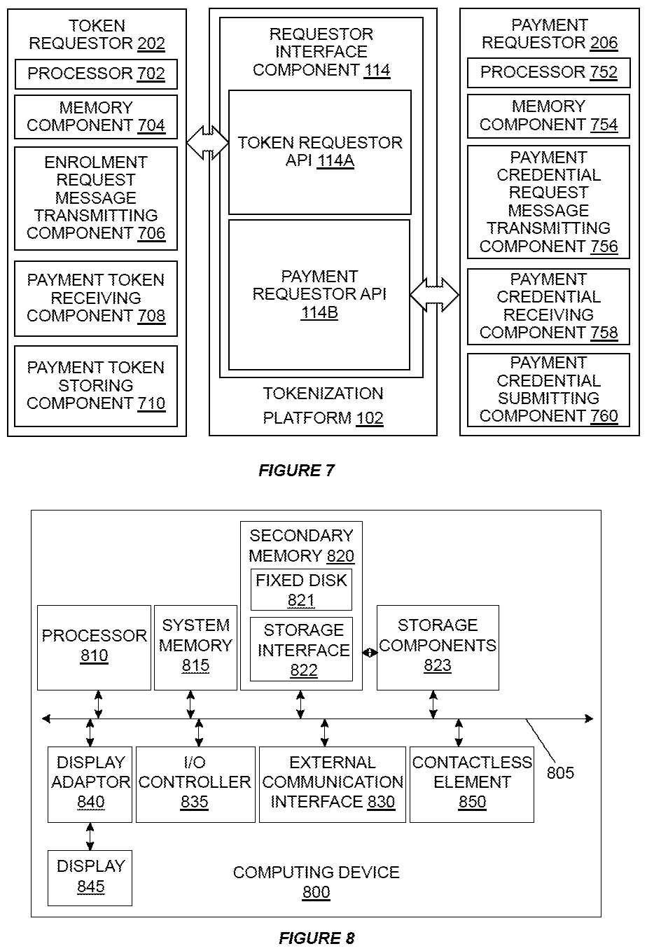

FIG. 7 is a block diagram illustrating example components of one embodiment of a tokenization system according to aspects of the present disclosure. The system includes a token requestor (202), a tokenization platform (102) and a payment requestor (206).

The token requestor (202) and payment requestor (206) interface with the tokenization platform via a requestor interface (114), which may for example include a token requestor API (114A) and a payment requestor API (114B).

The token requestor (202) includes a processor (702) for executing the functions of components described below, which may be provided by hardware or by software units executing on the token requestor (202). The software units may be stored in a memory component (704) and instructions may be provided to the processor (702) to carry out the functionality of the described components.

The token requestor (202) includes an enrolment request message transmitting component (706) arranged to transmit an enrolment request message to the tokenization platform. The token requestor (202) includes a payment token receiving component (708) arranged to receive a payment token from the tokenization platform. The token requestor (202) includes a payment token storing component (710) arranged to store the payment token for subsequent use in submitting one or more payment requests.

The payment requestor (206) includes a processor (752) for executing the functions of components described below, which may be provided by hardware or by software units executing on the payment requestor (206). The software units may be stored in a memory component (754) and instructions may be provided to the processor (752) to carry out the functionality of the described components.

The payment requestor (206) includes a payment credential request message transmitting component (756) arranged to transmit a payment credential request message to the tokenization platform (102). The payment requestor (206) includes a payment credential receiving component (758) arranged to receive the payment credential from the tokenization platform. The payment requestor (206) includes a payment credential submitting component (760) arranged to submit the payment credential to a payment network for processing a payment.

The term “consumer” as used herein may refer to any entity wishing to purchase or subscribe to goods and/or services from merchants.

The term “merchant” as used herein may refer to any entity offering for sale or subscription, goods and/or services to consumers.

The term “payment aggregator” as used herein may refer to a service provider through which e-commerce merchants can process their payment transactions. Aggregators may allow merchants to accept credit card and bank transfers without having to set up a merchant account with a bank or card association.

The term “payment gateway” as used herein may refer to a technology used by merchants to accept debit or credit card purchases from consumers. Payment gateways may be consumer-facing interfaces used to collect payment credentials. In physical stores, payment gateways may include the point of sale (POS) terminals used to accept credit card information by card or by smartphone. In online stores, payment gateways may be the “checkout” portals used to enter a payment credential for services.

The term “payment service provider” (PSP) as used herein may refer to a service provider that assists merchants to accept a wide range of online payment methods, such as online banking, credit cards, debit cards, e-wallets, cash cards, and more. Typically, a PSP can connect to multiple acquiring banks, card, and payment networks. In many cases, the PSP will fully manage these technical connections, relationships with the external network, and bank accounts and therefore takes care of the technical processing of payment methods for online shops.

The term “issuer” as used herein may refer to a financial institution with which the consumer has a financial account and by which the consumer is issued a payment credential associated with the account. An issuer may be a bank that offers card association branded payment cards directly to consumers, such as credit cards, debit cards, contactless devices such as key fobs as well as prepaid cards.

The term “payment credential” as used herein may refer to a set of data elements linked to a financial account or other store of value that enables a consumer to make financial transactions, such as payments. An example of a payment credential includes one or more of: a primary account number, card verification value, expiry date, cardholder name, and the like.

The term “payment network” as used herein may refer to a network of computing devices used to settle financial transactions through the transfer of monetary value. This may include computing devices of institutions, instruments and people and optionally rules, procedures, standards and other technologies that make its exchange possible.

FIG. 8 illustrates an example of a computing device (800) in which various aspects of the disclosure may be implemented. The computing device (800) may be embodied as any form of data processing device including a personal computing device (e.g. laptop or desktop computer), a server computer (which may be self-contained, physically distributed over a number of locations), a client computer, or a communication device, such as a mobile phone (e.g. cellular telephone), satellite phone, tablet computer, personal digital assistant or the like. Different embodiments of the computing device may dictate the inclusion or exclusion of various components or subsystems described below.

The computing device (800) may be suitable for storing and executing computer program code. The various participants and elements in the previously described system diagrams may use any suitable number of subsystems or components of the computing device (800) to facilitate the functions described herein. The computing device (800) may include subsystems or components interconnected via a communication infrastructure (805) (for example, a communications bus, a network, etc.). The computing device (800) may include one or more processors (810) and at least one memory component in the form of computer-readable media. The one or more processors (810) may include one or more of: CPUs, graphical processing units (CPUs), microprocessors, field programmable gate arrays (FPGAs), application specific integrated circuits (ASICs) and the like. In some configurations, a number of processors may be provided and may be arranged to carry out calculations simultaneously. In some implementations various subsystems or components of the computing device (800) may be distributed over a number of physical locations (e.g. in a distributed, cluster or cloud-based computing configuration) and appropriate software units may be arranged to manage and/or process data on behalf of remote devices.

The memory components may include system memory (815), which may include read only memory (ROM) and random access memory (RAM). A basic input/output system (BIOS) may be stored in ROM. System software may be stored in the system memory (815) including operating system software. The memory components may also include secondary memory (820). The secondary memory (820) may include a fixed disk (821), such as a hard disk drive, and, optionally, one or more storage interfaces (822) for interfacing with storage components (823), such as removable storage components (e.g. magnetic tape, optical disk, flash memory drive, external hard drive, removable memory chip, etc.), network attached storage components (e.g. NAS drives), remote storage components (e.g. cloud-based storage) or the like.

The computing device (800) may include an external communications interface (830) for operation of the computing device (800) in a networked environment enabling transfer of data between multiple computing devices (800) and/or the Internet. Data transferred via the external communications interface (830) may be in the form of signals, which may be electronic, electromagnetic, optical, radio, or other types of signals. The external communications interface (830) may enable communication of data between the computing device (800) and other computing devices including servers and external storage facilities. Web services may be accessible by and/or from the computing device (800) via the communications interface (830).

The external communications interface (830) may be configured for connection to wireless communication channels (e.g., a cellular telephone network, wireless local area network (e.g. using Wi-Fi™), satellite-phone network, Satellite Internet Network, etc.) and may include an associated wireless transfer element, such as an antenna and associated circuitry.

The external communications interface (830) may further include a contactless element (850), which is typically implemented in the form of a semiconductor chip (or other data storage element) with an associated wireless transfer element, such as an antenna. The contactless element (850) may be associated with (e.g., embedded within) the computing device (800) and data or control instructions transmitted via a cellular network may be applied to the contactless element (850) by means of a contactless element interface (not shown). The contactless element interface may function to permit the exchange of data and/or control instructions between computing device circuitry (and hence the cellular network) and the contactless element (850). The contactless element (850) may be capable of transferring and receiving data using a near field communications capability (or near field communications medium) typically in accordance with a standardized protocol or data transfer mechanism (e.g., ISO 14443/NFC). Near field communications capability may include a short-range communications capability, such as radio-frequency identification (RFID), Bluetooth™, infra-red, or other data transfer capability that can be used to exchange data between the computing device (800) and an interrogation device. Thus, the computing device (800) may be capable of communicating and transferring data and/or control instructions via both a cellular network and near field communications capability.

The computer-readable media in the form of the various memory components may provide storage of computer-executable instructions, data structures, program modules, software units and other data. A computer program product may be provided by a computer-readable medium having stored computer-readable program code executable by the central processor (810). A computer program product may be provided by a non-transient or non-transitory computer-readable medium, or may be provided via a signal or other transient or transitory means via the communications interface (830).

Interconnection via the communication infrastructure (805) allows the one or more processors (810) to communicate with each subsystem or component and to control the execution of instructions from the memory components, as well as the exchange of information between subsystems or components. Peripherals (such as printers, scanners, cameras, or the like) and input/output (I/O) devices (such as a mouse, touchpad, keyboard, microphone, touch-sensitive display, input buttons, speakers and the like) may couple to or be integrally formed with the computing device (800) either directly or via an I/O controller (835). One or more displays (845) (which may be touch-sensitive displays) may be coupled to or integrally formed with the computing device (800) via a display or video adapter (840).

The foregoing description has been presented for the purpose of illustration; it is not intended to be exhaustive or to limit the invention to the precise forms disclosed. Persons skilled in the relevant art can appreciate that many modifications and variations are possible in light of the above disclosure.

Any of the steps, operations, components or processes described herein may be performed or implemented with one or more hardware or software units, alone or in combination with other devices. Components or devices configured or arranged to perform described functions or operations may be so arranged or configured through computer-implemented instructions which implement or carry out the described functions, algorithms, or methods. The computer-implemented instructions may be provided by hardware or software units. In one embodiment, a software unit is implemented with a computer program product comprising a non-transient or non-transitory computer-readable medium containing computer program code, which can be executed by a processor for performing any or all of the steps, operations, or processes described. Software units or functions described in this application may be implemented as computer program code using any suitable computer language such as, for example, Java™, C++, or Perl™ using, for example, conventional or object-oriented techniques. The computer program code may be stored as a series of instructions, or commands on a non-transitory computer-readable medium, such as a random access memory (RAM), a read-only memory (ROM), a magnetic medium such as a hard-drive, or an optical medium such as a CD-ROM. Any such computer-readable medium may also reside on or within a single computational apparatus, and may be present on or within different computational apparatuses within a system or network.

Flowchart illustrations and block diagrams of methods, systems, and computer program products according to embodiments are used herein. Each block of the flowchart illustrations and/or block diagrams, and combinations of blocks in the flowchart illustrations and/or block diagrams, may provide functions which may be implemented by computer readable program instructions. In some alternative implementations, the functions identified by the blocks may take place in a different order to that shown in the flowchart illustrations.

Some portions of this description describe the embodiments of the invention in terms of algorithms and symbolic representations of operations on information. These algorithmic descriptions and representations, such as accompanying flow diagrams, are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention set forth in any accompanying claims.

Finally, throughout the specification and any accompanying claims, unless the context requires otherwise, the word ‘comprise’ or variations such as ‘comprises’ or ‘comprising’ will be understood to imply the inclusion of a stated integer or group of integers but not the exclusion of any other integer or group of integers.

1. A computer-implemented method conducted at a tokenization platform, comprising:
receiving, from a token requestor, an enrolment request message requesting enrolment of a payment credential for tokenization;
determining whether to obtain a payment token of a first type or a second type for the payment credential; and,
obtaining the payment token associated with the payment credential, including:
when the first type of token is determined to be obtained:
generating the first type of token using a tokenization algorithm;
storing the first type of token in association with the payment credential in a secure storage location accessible to the tokenization platform; and,
transmitting the first type of token as the payment token to the token requestor for use in submitting one or more payment requests; and,
when the second type of token is determined to be obtained:
interacting with a network tokenization service to request generation of the second type of token associated with the payment credential for transmitting the second type of token as the payment token to the token requestor for use in submitting one or more payment requests.

2. The method as claimed in claim 1, wherein the payment token is obtained for storage and subsequent use by the token requestor in submitting one or more payment requests.

3. The method as claimed in claim 1, wherein the enrolment request message includes data elements relating to one or more predefined conditions to be associated with the payment token.

4. The method as claimed in claim 1, wherein generating the first type of token includes accessing a bank identification number (BIN) from a BIN range associated with an issuer of the payment credential.

5. The method as claimed in claim 1, wherein generating the first type of token includes generating the first type of token without a BIN.

6. The method as claimed in claim 1, wherein generating the first type of token includes generating a character sequence that passes a validation algorithm.

7. The method as claimed in claim 1, wherein generating the first type of token includes generating a numerical sequence that passes a validation algorithm, wherein the validation algorithm is a Luhn algorithm.

8. The method as claimed in claim 1, wherein determining whether to obtain the payment token of the first type or the second type includes parsing the enrolment request message for one or more data elements instructing generation of the first type of token or the second type of token.

9. The method as claimed in claim 1, wherein determining whether to obtain the payment token of the first type or the second type includes checking whether the first type of token is supported for the payment credential.

10. The method as claimed in claim 1, wherein determining whether to obtain the payment token of the first type or the second type includes evaluating the enrolment request message against rules associated with one or both of the payment credential and the token requestor.

11. The method as claimed in claim 1, wherein determining whether to obtain the payment token of the first type or the second type includes evaluating contextual information included in or associated with the enrolment request message.

12. The method as claimed in claim 1, wherein the token requestor is a computing device of one of: a consumer; a merchant; a payment services provider; a payment gateway; or, a payment aggregator.

13. The method as claimed in claim 1, including:
receiving, from a payment requestor, a payment credential request message, the payment credential request message including the payment token and requesting the payment credential associated with the payment token;
obtaining the payment credential associated with the payment token; and,
transmitting the payment credential to the payment requestor for submitting to a payment processing network to process a payment.

14. The method as claimed in claim 13, wherein the payment requestor is a computing device of one of: a merchant; a payment services provider; a payment gateway; or, a payment aggregator.

15. The method as claimed in claim 13, wherein the payment requestor and the token requestor are one and the same.

16. The method as claimed in claim 1, wherein the first type of token is an issuer token and wherein the second type of token is a network token.

17. A system including a tokenization platform including a memory for storing computer-readable program code and a processor for executing the computer-readable program code, the system comprising:
an enrolment request message receiving component for receiving, from a token requestor, an enrolment request message requesting enrolment of a payment credential for tokenization;
a token type determining component for determining whether to obtain a payment token of a first type or a second type for the payment credential; and,
a payment token obtaining component for obtaining the payment token associated with the payment credential, including:
for when the first type of token is determined to be obtained:
a token generating component for generating the first type of token using a tokenization algorithm;
a payment token storing component for storing the first type of token in association with the payment credential in a secure storage location accessible to the tokenization platform; and,
a payment token transmitting component for transmitting the first type of token as the payment token to the token requestor for use in submitting one or more payment requests; and,
for when the second type of token is determined to be obtained:
a network tokenization service interacting component for interacting with a network tokenization service to request generation of the second type of token associated with the payment credential for transmitting the second type of token as the payment token to the token requestor for use in submitting one or more payment requests.

18. The system as claimed in claim 17, including:
a payment credential request message receiving component for receiving, from a payment requestor, a payment credential request message, the payment credential request message including the payment token and requesting the payment credential associated with the payment token;
a payment credential obtaining component for obtaining the payment credential associated with the payment token; and,
a payment credential transmitting component for transmitting the payment credential to the payment requestor for submitting to a payment processing network to process a payment.

19. The system as claimed in claim 18, including a computing device of the payment requestor, including:
a payment credential request message transmitting component for transmitting the payment credential request message;
a payment credential receiving component for receiving the payment credential; and,
a payment credential submitting component for submitting the payment credential to a payment network for processing a payment.

20. A computer program product comprising a computer-readable medium having stored computer-readable program code for performing, at a tokenization platform, the steps of:
receiving, from a token requestor, an enrolment request message requesting enrolment of a payment credential for tokenization;
determining whether to obtain a payment token of a first type or a second type for the payment credential; and,
obtaining the payment token associated with the payment credential, including:
when the first type of token is determined to be obtained:
generating the first type of token using a tokenization algorithm;
storing the first type of token in association with the payment credential in a secure storage location accessible to the tokenization platform; and,
transmitting the first type of token as the payment token to the token requestor for use in submitting one or more payment requests; and,
when the second type of token is determined to be obtained:
interacting with a network tokenization service to request generation of the second type of token associated with the payment credential for transmitting the second type of token as the payment token to the token requestor for use in submitting one or more payment requests.
